(19) United States
(12) Patent Application Publication
(10) Pub. No.: US 2002/0054708 A1
(43) Pub. Date: May 9, 2002

(54) Video apparatus having a function for image analysis

(76) Inventor: Naoyuki Murakami, Setagaya-ku (JP)

Correspondence Address: OLIFF & BERRIDGE, PLC, P.O. BOX 19928, ALEXANDRIA, VA, 22320, US

(21) Appl. No.: 09/925,321

(22) Filed: Aug. 10, 2001

(30) Foreign Application Priority Data
Aug. 10, 2000 (JP) 2000-242256

(51) Int. Cl. G06K 9/68

(52) U.S. Cl. 382/218

(57) ABSTRACT

The present video apparatus comprises: a device for generating a video signal; a memory including a storage region for storing a program and a storage region for storing a data of an analysis; an internal analysis processing circuit for an image analysis from the video signal according to the procedure of the image analyzing program to output a video signal of the image analysis to an external unit: an addressing circuit for assigning an address in the video signal from the result of the image analysis; and a comparison circuit for comparing the video signal assigned the address to a video signal of an image set up by the program to output the video signal to the internal analysis processing circuit if both of the video signals are the same.

### BACKGROUND OF THE INVENTION

This invention relates to a video apparatus having a function to analyze a picture image quickly with video signals from a video camera, a videocassette recorder or such like.

The picture image in the video apparatus is usually refreshed by 60 or more fields per one second. A video signal is accumulated for every field into a frame memory and then is transmitted to a monitor.

A video camera, which is an example of a video apparatus employs CCD, i.e. charge couple device, as an image pick-up element. Recently, a density of CCD elements is raised in order for taking a high resolution of a picture. According to such high resolution, the capacity of the frame memory is also large. The videocassette recorder is also formed into such a high resolution and is the same situation.

Conventionally, a video apparatus is applied for a surveillance camera of a security installation or an automatic machinery line, an amusement apparatus and a medical apparatus. An image analysis, which recognizes a form, a color, a coordinate and/or etc. of a designating picture image from video signal of output of such a video apparatus, is performed.

Such conventional image analysis was operated through accumulating the video signal for every field in a frame memory of processing circuit to analyze. A capacity of such frame memory grows large as like recent technology, it thus takes a great time for the above-mentioned operation of the analysis. It was frequent that the operation processing did not meet the deadline of the time when one field was completed before the next field appeared unless the processing circuit has a very quick processing speed. When the image analysis processing was carried out one after another, outputting delay might accumulate to cause trouble.

### SUMMARY OF THE INVENTION

The present invention is invented in order to solve such problems. The object of the present invention is a supply of a video apparatus which can quickly analyze a picture image.

The video apparatus, of the present invention for completing the above-mentioned object, having a unit for an image analysis comprises: a device for generating a video signal; a memory including a storage region for storing an image analyzing program and a storage region for storing an operating data of an analysis; an internal analysis processing circuit for carrying out an image analysis from the video signal according to the procedure of the image analyzing program to output a video signal resultant of the image analysis to an external unit; an address assignment circuit for assigning an address in the video signal from the result of the image analysis; and a comparison circuit for comparing the video signal assigned the address to C video signal of an image set up by the image analyzing program to output the video signal to the internal analysis processing circuit if both of the video signals are the same or similar.

In the video apparatus of the present invention, the video signal may comprise signals of three primary colors and a synchronizing signal.

In the video apparatus of the present invention, the external unit may comprise the input and output means for the image analyzing program and a control processing circuit connecting to a display.

In the video apparatus of the present invention, the device for generating the video signal may be a video camera.

### BRIEF EXPLANATION OF THE DRAWINGS

FIG. 1 shows a block diagram of an embodiment of the video apparatus applied the present invention.

FIG. 2 shows an outline composition view of an embodiment of a device for generating the video signal of the video apparatus applied the present invention.

FIG. 3 shows a flow chart for a procedure of an image analyzing program of the video apparatus applied the present invention.

### DETAILED DESCRIPTION OF THE INVENTION

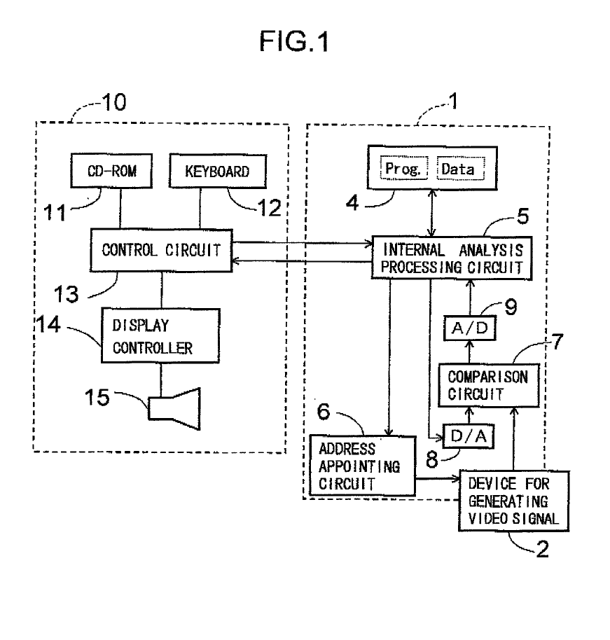

As showing in FIG. 1, the present video apparatus having unit 1 for an image analysis comprises: device 2 for generating video signal; memory 4 including a storage region for storing an image analyzing program and a storage region for storing an operating data of an analysis; internal analysis processing circuit 5 for carrying out an image analysis from the video signal according to the procedure of the image analyzing program to output a video signal resultant of the image analysis to external unit 10; address assignment circuit 6 for assigning an address in the video signal from the result of the image analysis; and comparison circuit 7 for comparing the video signal assigned the address to a video signal of an image set up by the image analyzing program to output the video signal to the internal analysis processing circuit 5 if both of the video signals are the same or similar.

When the device 2 generates a video signal of a whole of a picture image, it is compared to a video signal designated from the image analyzing program by comparison circuit 7 arid a part of the video signal of the whole thus is selected as the same or similar to the designated video signal to enter through the circuit 5 into the address assignment circuit 6. The address of the partial video signal is assigned thereby to enter the device 2. The video signal assigned the address then enters into the internal analysis processing circuit 5.

The internal analysis processing circuit 5 processes such a partial video signal of the designated image. Therefore, it will be very quick to analyze the partial video signal comparing to analyzing the video signal of the whole picture image.

Hereinafter, the desirable implementation of the present invention will be explained in further detail referring drawings. However, the claimed invention is not limited by the implementation.

As shown in FIG. 1, an image analysis unit 1 of the present video apparatus is united with an internal analysis processing circuit 5 as center thereof, a memory 4, an address assignment circuit 6, a comparison circuit 7, a digital-analog (D/A) converter 8, an analog-digital (A/D) converter 9 and a device 2 for generating a video signal. The internal analysis processing circuit 5 connects to an external unit 10.

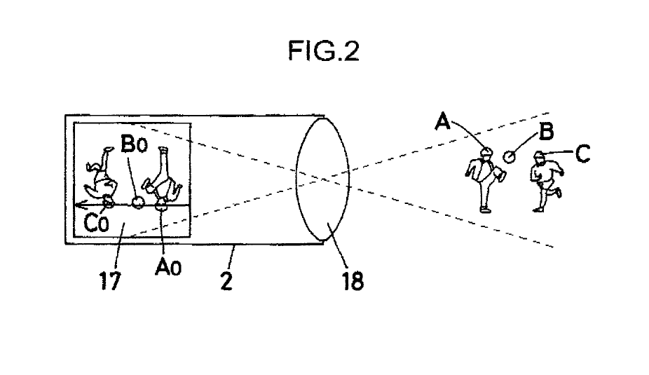

As shown in FIG. 2, the device 2 for generating the video signal is a video camera 2 employing an image objective lens 18 and charge couple device, i.e. CCD, 17 as solid image pick-up elements. The video camera 2 emits a refreshing signal for every end of an image field with the video signal. The address range of the video signal is assigned by the address assignment circuit 6.

External apparatus 10 uses a function of a personal computer. The personal computer arranges a control circuit 13 as center thereof, a CD-ROM 11 which has memorized C software of an image analysis program, a keyboard 12, a display controller 14, and a cathode-ray tube (CRT) 15.

As seen FIG. 2, two boys A and C are playing soccer with a ball B. The image analysis of the ball B by this video apparatus will be explained.

Images of the two boys A and C and the soccer ball B are projected on CCD 17 with the lens 18. An arrow line, which crosses on the CCD 17, represents one scanning line thereof.

At a state of usual display, a refreshing signal goes into CCD 17 in a usual cycle for projecting a whole of an image picture from the address assignment circuit 6 since the image analysis program is not performed. Therefore, two boys A and C and the soccer ball B are displayed on the CRT 15.

In order to perform the image analysis, the software of the image analysis program is loaded in the control circuit 13 by commanding with the keyboard 12 from the CD-ROM 11. Subsequently, setting image, which should be analyzed, is set up into the control circuit 13. In this example, the soccer ball B is selected being analyzed. A form, size and color of a ball image are thus inputted into there with the keyboard 13. Furthermore, analyzing items of the ball B is set up into the control circuit 13. As analyzing terns in this example, a flight direction, flight speed and predictive flight distance of the soccer ball are inputted into there.

The control circuit 13 incorporates the form, size, color taken in as image for being analyzed and the flight direction, flight speed and flight prediction distance taken in as items for analyzing with the image analysis program. The executive image analysis program being incorporated with these data are transmitted from the control circuit 13 to the image analysis unit 1. The executive image analysis program sends through the internal analysis processing circuit 5 and then stores into the storage region for program of the memory 4.

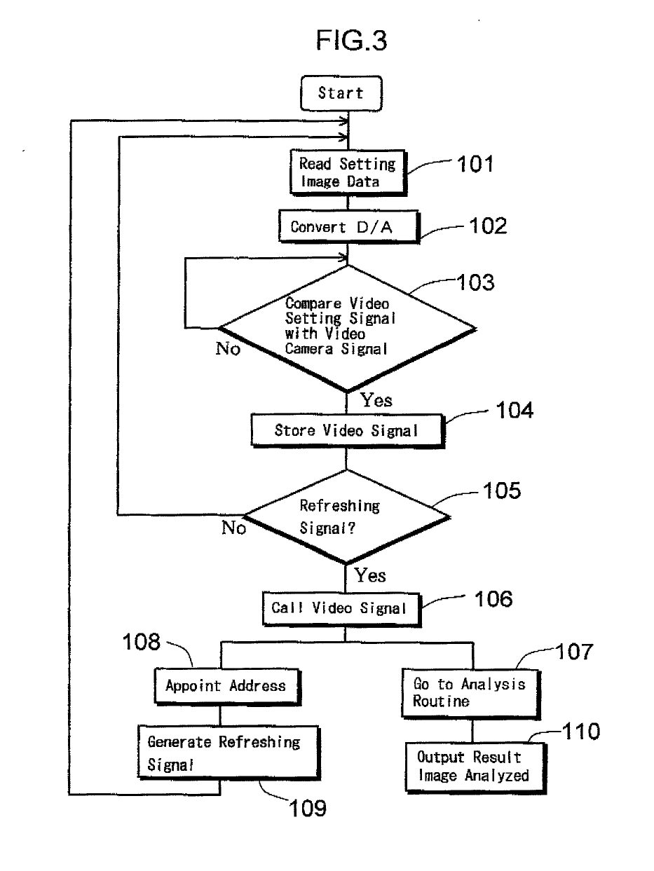

Hereafter, the executive image analysis program is performed according to a flow chart shown in FIG. 3.

As the above described, the whole image picture projected on the CCD 17 (see FIG. 2) of video camera 2 is displayed on the CRT 15 before starting the image analysis program.

After starting the program, setting image data of the form, size and color of the ball image reads from the memory 4 into the internal analysis processing circuit 5 at Step 101. The setting image data is converted to analog signal by the D/A converter 8 at Step 102. The video analog signal of the setting image, which has a homogeneous waveform to a video analog signal from the video camera 2, inputs in the comparison circuit 7. In addition, although the video signal consists of three primary color signals, processing of only one color video signal will be indicated here since equivalent processing is carried out among each monochrome signal.

On the other hand, the video analog signal has inputted into the comparison circuit 7 from the video camera 2 by a refresh rate of the whole picture image and is compared with the video analog signal of the setting image at Step 103. A scanning line crosses on the whole image picture of FIG. 2 in order of images Ao→Bo→Co. The video camera signal thus inputs in the comparison circuit 7, if the video camera signal corresponds with the setting video signal, that means scanning point of the whole picture image goes into an area of ball Bo, a video signal output from the comparison circuit 7 This signal is converted to digital signal with A/D converter 9 to input into the internal analysis processing circuit 5. The internal analysis processing circuit 5 carries out this digital video signal to store in the memory 4 at Step 104.

A looping operation from step 101 to Step 105 is continued until finishing one cycle of field of the whole picture image, that means until a refreshing signal input from the video camera 2 at Step 105. If the refreshing signal inputs the internal analysis processing circuit 5, the video signal is called from the memory 4 at Step 106 to be transmitted to an analysis routine at Step 107.

The internal analysis processing circuit 5 outputs timing signal for addressing to the address assignment circuit 6 at Step 108. Such timing signal can obtain adding any margin time to before and after the time of the video signal, that is same to the setting video signal, called from the memory 4 at Step 106.

The address assignment circuit 6 generates a refreshing signal from the timing signal and transmits to the video camera 2 at step 109. Consequently, refreshment of picture image of the video camera 2 appears by a little larger area than the soccer ball Bo. Image refreshing is repeated through a loop of step 101→step 102→step 103→step 104→step 105→step 106→step 108→step 109→step 101 until completing to scan such larger area.

On the other hand, the video signals having the larger area than ball Bo accumulated in memory 4 output to an analysis routine of Step 107 by every loop. The analysis routine is a usual operation program in the internal analysis processing circuit 5 for analyzing a flight direction, flight speed, and flight prediction distance of a bail from displacements of ball coordinates. The result of the image analyzed by the analysis routine is outputted to a control circuit 13 of external apparatus 10 at Step 110.

It is arbitrary using a function of a usual personal computer in the control circuit 13 that the result of the image analyzed is displayed on CRT 15 through display controller 14 or memorizes into a memory device.

Since the image analysis of the present video apparatus analyzes partial signal addressed the same video signal as a setting image signal, analysis of an unnecessary portion is omitted and it can perform high-speed processing.

Although the form, size and color of ball B are taken for the setting image in the above-explained implementation and, however, such setting may use other elements than image. For example, moving speed, quantity, address or combinations of these may be set up as setting elements.

Moreover, CD-ROM 11 and a keyboard 12 are employed as input-and-output means for the image analysis program of external apparatus 10 and, however, combining floppy disk, a stick memory, a mouse, etc. may be suitably employed. A device for generating a video signal is not limited by a video camera and may be a videocassette recorder, a television receiving set, computer or as such having an output of a video image signal.

As mentioned above, the analysis of the present video apparatus is omissible for unnecessary portion of the video image signal so that is very quick without using powerful and large analysis device. Since the image to analyze does not require a moving image nor a still image, it can apply broadly for line management of security installations, such as a surveillance camera, or an automatic machine, the application to amusement apparatus or medical apparatus, etc.

What is claimed is:

1 A video apparatus having a unit for an image analysis comprising:
a device for generating a video signal;
a memory including a storage region for storing an image analyzing program and a storage region for storing an operating data of an analysis;
an internal analysis processing circuit for carrying out an image analysis from the video signal according to the procedure of the image analyzing program to output a video signal resultant of the image analysis to an external unit;
an address assignment circuit for assigning an address in the video signal from the result of the image analysis; and
a comparison circuit for comparing the video signal assigned the address to a video signal of an image set up by the image analyzing program to output the video signal to the internal analysis processing circuit if both of the video signals are the some or similar.

2 The video apparatus according to claim 1 wherein the video signal comprises signals of three primary colors and a video synchronizing signal.

3 The video apparatus according to claim 1, wherein the external unit comprises the input and output means for the image analyzing program and a control processing circuit connecting to a display.

4 The video apparatus according to claim 1, wherein the device for generating the video signal is a video camera.
